(19) United States
(12) Patent Application Publication
(10) Pub. No.: US 2025/0259029 A1
(43) Pub. Date: Aug. 14, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: HIROYASU KUNIEDA, Kanagawa (JP); AKITOSHI YAMADA, Kanagawa (JP); YOICHI KASHIBUCHI, Kanagawa (JP)

(21) Appl. No.: 19/052,048

(22) Filed: Feb. 12, 2025

(30) Foreign Application Priority Data
Feb. 13, 2024 (JP) 2024-019859

(51) Int. Cl. G06K 15/02

(52) U.S. Cl. CPC G06K 15/189; G06K 2215/101

(57) ABSTRACT

An image processing apparatus that generates a multiplexed image for executing printing in a printing machine that includes either a first apparatus using an electrophotographic method or a second apparatus using an inkjet method, the image processing apparatus includes a print data acquisition unit configured to acquire print data to be printed onto a print medium, an information acquisition unit configured to acquire embedment information, and an image generation unit configured to embed the embedment information into the print data in such a manner that an embedment strength at which the embedment information is embedded into the same print data becomes stronger in a case where the printing machine uses the electrophotographic method than that in a case where the printing machine uses the inkjet method.

### BACKGROUND

### Field of the Disclosure

The present disclosure relates to information multiplexing processing on a document.

### Description of the Related Art

Techniques for utilizing and storing an electronic document as an original in place of a paper document have been implemented. As a result, there has arisen a case where an electronic document is regarded as an original and a paper document obtained by printing it on paper is handled as a copy thereof.

There has been accordingly used a method of embedding management information into a printed document in order to determine the authenticity of texts printed on paper. In printing onto paper, a document is generated by various printing methods such as an electrophotographic method and an inkjet method. Japanese Patent Application Laid-Open No. 2000-299779 discusses embedding unnoticeable information into a printed material using the inkjet method.

Nevertheless, in the technique discussed in Japanese Patent Application Laid-Open No. 2000-299779, it is not supposed to embed information using a printing method such as the electrophotographic method that is other than the inkjet method. For this reason, in a case where similar processing is performed also in a printing process of the electrophotographic method, if embedding processing is performed at the same strength as that in the inkjet method, the extraction accuracy of embedment information degrades.

### SUMMARY

According to embodiments of the present disclosure, an image processing apparatus that generates a multiplexed image for executing printing in a printing machine that includes either a first apparatus using an electrophotographic method or a second apparatus using an inkjet method, the image processing apparatus includes a print data acquisition unit configured to acquire print data to be printed onto a print medium, an information acquisition unit configured to acquire embedment information, and an image generation unit configured to embed the embedment information into the print data in such a manner that an embedment strength at which the embedment information is embedded into the same print data becomes stronger in a case where the printing machine uses the electrophotographic method than that in a case where the printing machine uses the inkjet method.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a printing system.

FIGS. 2A and 2B are each a flowchart illustrating authentic document ID information embedding processing and extraction processing.

FIG. 3 is a diagram illustrating an example of document data.

FIGS. 4A and 4B are diagrams each illustrating a mask that generates an image variation.

FIGS. 5A and 5B are diagrams each visually illustrating a pattern.

FIGS. 6A and 6B are diagrams each illustrating a mask that generates an image variation.

FIGS. 7A and 7B are diagrams each visually illustrating a pattern.

FIG. 8 is a flowchart illustrating tamper determination processing.

FIGS. 9A and 9B are diagrams illustrating a modified example of an embedding method according to a first exemplary embodiment.

FIGS. 10A and 10B are diagrams each illustrating an example of pattern degradation and embedded data enhancement.

FIG. 11 is a flowchart illustrating processing of changing a multiplexing strength at which information is to be embedded, depending on a printing method.

FIG. 12 is a flowchart illustrating processing of changing a color plane of an image onto which information is to be multiplexed, depending on a printing method.

FIGS. 13A to 13D are diagrams each illustrating an embedment mask to be used in multiplexing, for each strength.

FIG. 14 is a flowchart illustrating processing of changing an image density at which information is to be embedded, depending on a printing method.

FIG. 15 is a diagram illustrating an example of a table to be referred to at the time of image density change, for each strength.

FIG. 16 is a diagram illustrating a space frequency characteristic of a pattern used in embedding.

FIGS. 17A and 17B are schematic diagrams illustrating multifunction printers (MFPs) of an inkjet method and an electrophotographic method.

FIG. 18 is a diagram schematically illustrating image formation in the electrophotographic method.

### DESCRIPTION OF THE EMBODIMENTS

Hereinafter, exemplary embodiments will be described with reference to the accompanying drawings. The following exemplary embodiments are not intended to limit the disclosure. Not all the combinations of features described in the present exemplary embodiment are essential to the solution of the present disclosure. The same components are assigned the same reference numerals, and redundant descriptions will be omitted. Hereinafter, image data representing an image will be sometimes simply referred to as an image.

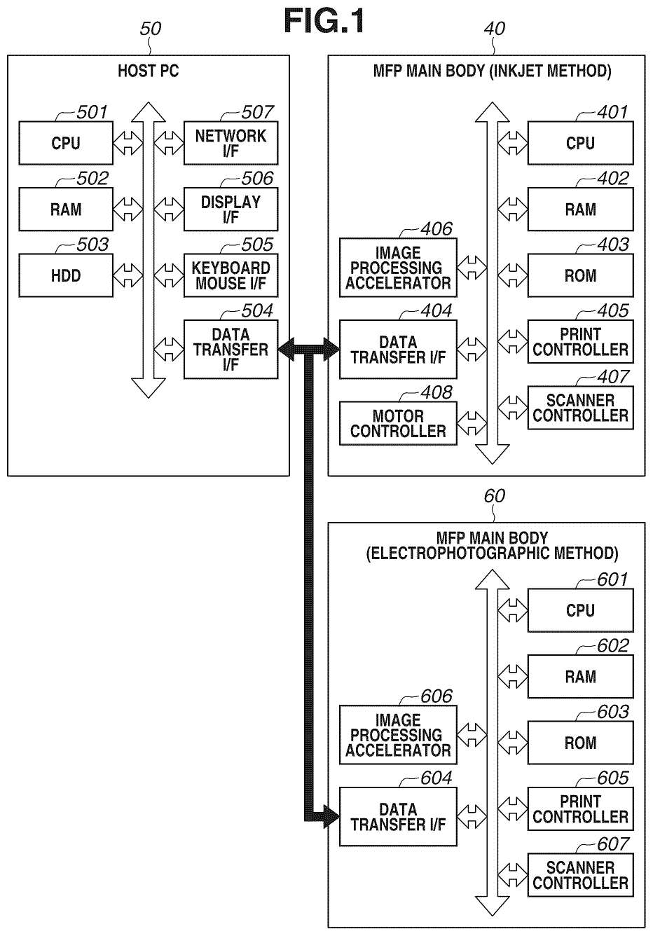

A first exemplary embodiment of the present disclosure will be described below. FIG. 1 is a block diagram illustrating a configuration of a printing system that prints a multiplexed document. This printing system includes a multifunction printer (MFP) apparatus 40 that employs an inkjet method as a printing method, an MFP apparatus 60 that employs an electrophotographic method as a printing method, and a personal computer (PC) 50 serving as a host apparatus of these apparatuses. Here, an MFP main body refers to a printer having a plurality of functions such as a printer function and a scanner function, and sometimes has a copy function to be executed in conjunction with the plurality of functions.

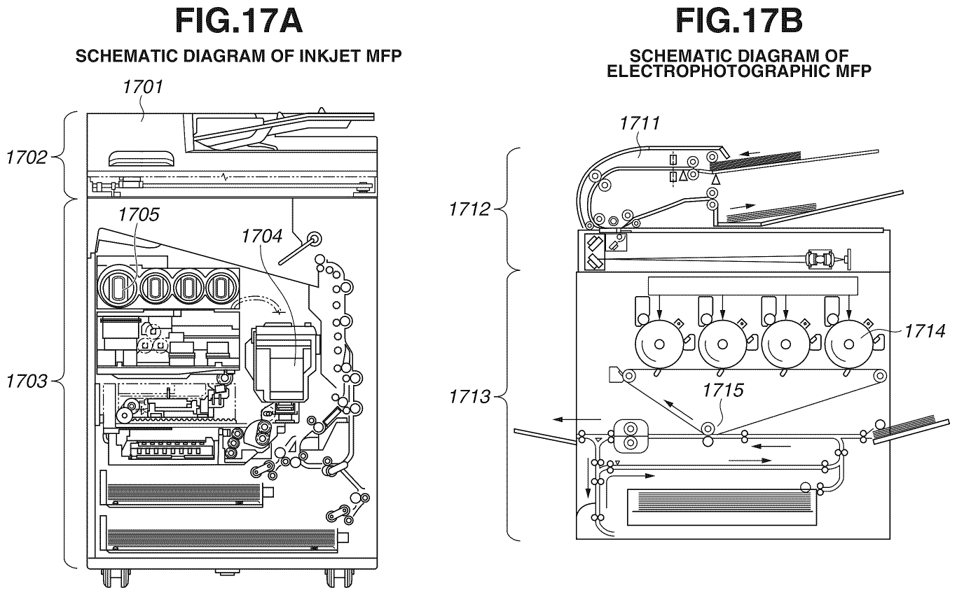

FIGS. 17A and 17B are schematic diagrams of MFPs. FIG. 17A is a schematic diagram illustrating an MFP of the inkjet method and FIG. 17B is a schematic diagram illustrating an MFP of the electrophotographic method. An MFP 1701 of the inkjet method includes a scanner unit 1702 and a print unit 1703. The print unit 1703 includes a recording head 1704 and an ink tank unit 1705. The recording head 1704 ejects ink in accordance with print data. The ink tank unit 1705 stores ink to be supplied to the recording head 1704. The color of ink (color material) to be stored include cyan, magenta, yellow, and black. Depending on the model, ink of a spot color is separately stored.

An MFP 1711 of the electrophotographic method includes a scanner unit 1712 and a print unit 1713. The print unit 1713 includes photosensitive drums 1714 and a transfer roller 1715. The photosensitive drums 1714 corresponds in number to color materials. Cyan toner, magenta toner, yellow toner, and black toner correspond to the respective photosensitive drums 1714. A latent image is formed on the photosensitive drum 1714 in accordance with print data. The transfer roller 1715 transfers the formed latent image to a conveyed sheet serving as a printing medium, and print processing is executed.

The host PC 50 mainly includes the following components. A central processing unit (CPU) 501 executes processing in accordance with a program stored in a hard disk drive (HDD) 503 or a random access memory (RAM) 502. The RAM 502 is a volatile storage, and temporarily stores programs and data. The HDD 503 is a nonvolatile storage, and stores programs and data as well. A data transfer interface (I/F) 504 controls data transmission and reception between the MFP main body 40 and the MFP main body 60. As a connection method of the data transmission and reception, wire connection such as universal serial bus (USB) connection, IEEE1394 connection, or a local area network (LAN) connection, or wireless connection such as Bluetooth® connection or WiFi® connection can be used. In a case where a printer model type is set by a driver at the time of printing, print data is transmitted to a designated MFP via the data transfer I/F 504. A keyboard mouse I/F 505 controls a human interface device (HID) such as a keyboard and a mouse, and the user can provide input via the keyboard mouse I/F 505. A display I/F 506 controls display on a display (not illustrated). A network I/F 507 connects the host PC 50 to an external network, communicates with one or a plurality of external PCs, and issues a document ID verification request, a document ID verification result request, and a document data request.

On the other hand, the MFP main body 40 employing the inkjet method as a printing method mainly includes the following components. A CPU 401 executes processing in accordance with a program stored in a ROM 403 or a RAM 402. The RAM 402 is a volatile storage, and temporarily stores programs and data. The ROM 403 is a nonvolatile storage, and can store table data and programs to be used in processing. A data transfer I/F 404 controls data transmission and reception between the MFP main body 40 and the host PC 50. A print controller 405 can be configured to read control parameters and recording data from a predetermined address in the RAM 402. The MFP main body 40 controls a heating operation of a print head in accordance with recording data based on the control parameters to eject ink, thus performing print processing. An image processing accelerator 406 includes hardware components, and executes image processing at higher speed than the CPU 401. Specifically, the image processing accelerator 406 can be configured to read parameters and data to be used for image processing from a predetermined address in the RAM 402. The CPU 401 writes the above-described parameters and data to the predetermined address in the RAM 402, and then the image processing accelerator 406 is activated and predetermined image processing is performed.

The image processing accelerator 406 is not necessarily an essential component, and as a matter of course, the above-described table parameter generation processing and image processing may be executed only through processing executed by the CPU 401, depending on the specification of a printer. A scanner controller 407 issues an instruction to a scanner unit (not illustrated) to transmit information regarding an amount of light acquired by an image sensor such as a charge-coupled device (CCD) image sensor from light emitted to a document and reflected light, to the scanner controller 407.

Specifically, if the CPU 401 writes a control parameter and a read data writing address to the above-described predetermined address in the RAM 402, processing is activated by the scanner controller 407. Light emission control of a light-emitting diode (LED) mounted on the scanner unit, the acquisition of light amount information from the scanner unit, and light amount information writing to a read data writing address in the RAM 402 are performed. A motor controller 408 controls motor operations of a plurality of motor units (not illustrated). A motor is used to relatively move the above-described print head with respect to a recording sheet, and to relatively move the scanner unit with respect to a document to be read. Aside from these, some MFPs include a motor for maintenance of a recording head.

The MFP main body 60 employing the electrophotographic method as a printing method has a configuration similar to that of the MFP main body 40 of the inkjet method, but differs in a print device portion. A print controller 605 performs development and transfer to a drum surface in accordance with print data based on a control parameter from a predetermined address in a RAM 602, thus performing print processing.

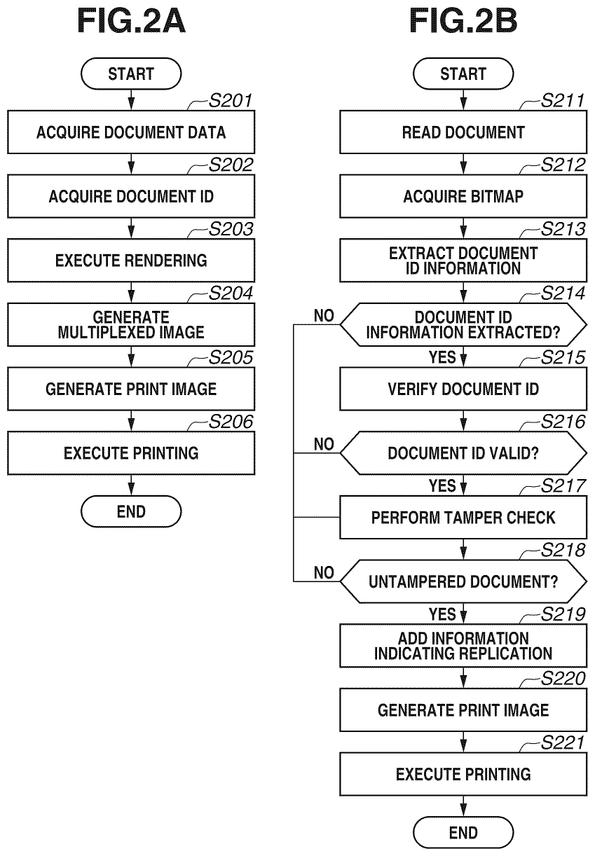

FIGS. 2A and 2B are each a flowchart illustrating authentic document ID information embedding processing and extraction processing according to a first exemplary embodiment. Each process (step) in the flowchart is indicated using a reference numeral starting from “S”. In FIGS. 2A and 2B, operations in steps S201 to S205 correspond to authentic document ID information embedding processing and operations in steps S211 to S221 correspond to authentic document ID information extraction processing.

Initially, processing to be executed at the time of inkjet recording will be described. Hereinafter, the authentic document ID information embedding processing will be described.

In step S201, the host PC 50 acquires document data. Specifically, in the present exemplary embodiment, the host PC 50 connects to an external PC via the network I/F 507, and acquires document data by requesting the document data.

Here, the document data is assumed to be described in a page description language (PDL). The PDL includes a set of draw commands for each page. The types of draw commands are defined for each PDL specification. In the present exemplary embodiment, the following three types are mainly used as examples.
Command 1) TEXT draw command (X1, Y1, color, font information, character string information)
Command 2) BOX draw command (X1, Y1, X2, Y2, color, painting shape)
Command 3) IMAGE draw command (X1, Y1, X2, Y2, image file information)

Moreover, draw commands such as a DOT draw command for drawing a dot, a LINE draw command for drawing a line, or a CIRCLE draw command for drawing a circular arc are appropriately used depending on a use application.

Commonly-used PDLs include a portable document format (PDF) proposed by the Adobe Inc., an Extensible Markup Language (XML) Paper Specification (XPS) proposed by the Microsoft Corporation, and Hewlett-Packard Graphics Language (HP-GL/2) proposed by the Hewlett-Packard Company. An application range of embodiments of the present disclosure is not limited to these.

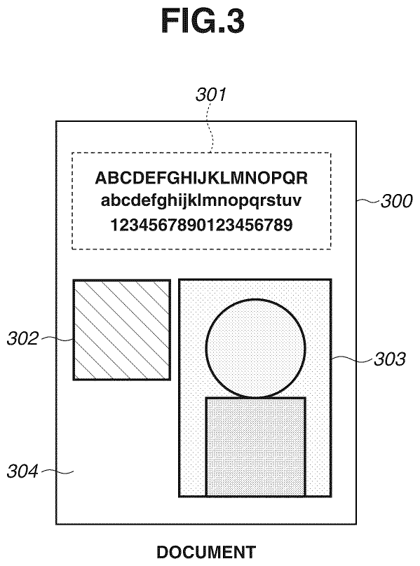

FIG. 3 illustrates an example of document data. A document 300 indicates one page of document data, and has a size of 600 pixels horizontal by 900 pixels vertical as the number of pixels.

An example of PDL corresponding to the document data in FIG. 3 is indicated below.

```
<PAGE=001>
    <TEXT> 50,50, 550, 100, BLACK, STD-18, “ABCDEFGHIJKLMNOPQR” </TEXT>
    <TEXT> 50,100, 550, 150, BLACK, STD-18,
“abcdefghijklmnopqrstuv” </TEXT>
    <TEXT> 50,150, 550, 200, BLACK, STD-18,
  “1234567890123456789” </TEXT>
    <BOX> 50, 300, 200, 450, GRAY, STRIPE </BOX>
    <IMAGE> 250, 300, 550, 850, “PORTRAIT.jpg” </IMAGE>
</PAGE>
```

<PAGE=001> in the first line is a tag indicating a page number in the present exemplary embodiment. The PDL is normally designed to be able to describe a plurality of pages, a tag indicating a page break is described in the PDL. In the present exemplary embodiment, the PDL indicates that a section up to </PAGE> in the ninth line indicates the first page, and corresponds to the document 300 illustrated in FIG. 3. In a case where the second page is present, <PAGE=002> is described following the above-described PDL.

A section from <TEXT> in the second line up to </TEXT> in the third line indicates a draw command 1, and corresponds to the first line in a character part 301. Leading two coordinates indicates a coordinate (X1, Y1) corresponding to a drawing region upper left, and the following two coordinates indicates a coordinate (X2, Y2) corresponding to a drawing region lower right. Subsequently, the draw command 1 indicates that color is black (black color: R=0, G=0, B=0), a character font is standard (STD), a character size thereof is 18 points, and a character string to be described is “ABCDEFGHIJKLMNOPQR”.

A section from <TEXT> in the fifth line up to </TEXT> in the sixth line indicates a draw command 2, and corresponds to the second line in the character part 301. As in the draw command 1, leading four coordinates indicate drawing regions and two character strings indicate a character color and a character font, and the draw command 2 then indicates that a character string to be described is “abcdefghijklmnopqrstuv”.

A section from <TEXT> in the seventh line up to </TEXT> in the eighth line indicates a draw command 3, and corresponds to the third line in the character part 301. As in the draw commands 1 and 2, leading four coordinates indicate drawing regions and two character strings indicate a character color and a character font, and the draw command 3 then indicates that a character string to be described is “1234567890123456789”.

A section from <BOX> to </BOX> in the ninth line indicates a draw command 4, and corresponds to a rectangle drawing part 302. Leading two coordinates indicates an upper left coordinate (X1, Y1) serving as a drawing start point, and the following two coordinates a lower right coordinate (X2, Y2) serving as a drawing end point. Subsequently, GRAY (gray color: R=128, G=128, B=128) is designated as a color and STRIPE (stripe pattern) is designated as a painting shape. In the present exemplary embodiment, the direction of lines in the stripe pattern is set to a constant lower right direction, but an angle and a cycle of the lines may be designated in the BOX command.

Subsequently, an IMAGE command in the tenth line corresponds to an image part 303. In this example, the IMAGE command describes that a file name of an image existing in the region is “PORTRAIT.jpg”, and this indicates that an image file is a JPEG file which is a commonly-used image compression format.

The description of </PAGE> in the eleventh line indicates that drawing of the page has ended.

As an actual PDL file, a file integrally including “STD” font data and the “PORTRAIT.jpg” image file in addition to the draw commands described above is used in many cases. This is because, in a case where font data and an image file are separately managed, characters and image portions cannot be formed only by the draw commands, and information is insufficient for forming the image illustrated in FIG. 3.

The document data to be acquired in step S201 in FIG. 2A has been described above.

In step S202, the host PC 50 acquires a document ID indicating the authenticity of the document data acquired in step S201. The document ID is information calculated based on all document files including the PDL file, the font data, and the image file that have been described above, and is 128-bit information in the present exemplary embodiment. A calculation method for the document ID information is designed in such a manner that a document ID to be calculated varies in a case where any of the files included in a document is changed. Thus, a unique document ID is allocated to a document file. Specifically, in the present exemplary embodiment, the host PC 50 transmits a request for a document ID to an external PC from which a document file has been acquired in step S201, and receives the document ID.

As another implementation method, by employing a block-chain-like configuration, where document data and document IDs are managed in a plurality of external PCs and the host PC 50 requests document IDs from the plurality of PCs, it is possible to reduce the possibility of the document IDs themselves being tampered with.

Subsequently, the processing proceeds to step S203, in which the host PC 50 performs rendering processing of the document data acquired in step S201. This is a step of executing each draw command described in the PDL, and forming a bitmap image constructed by color information for each pixel.

In the present exemplary embodiment, the document 300 illustrated in FIG. 3 has the size of 600 pixels horizontally and 900 pixels vertically as described above, a bitmap image to be generated in this step includes 600×900 pixels. Each pixel has 256 levels of grayscale with 8-bit for each R/G/B.

In step S204, the host PC 50 generates an image for multiplexing.

In this step, the host PC 50 superimposes the document ID information acquired in step S202, onto the rendering image generated in step S203. This operation is performed to enables a copying machine to extract a document ID from a scanned document when the copying machine copies an output material obtained by printing the superimposed image, and to enable the determination as to whether the output material itself is based on a digital document managed with a document ID.

Handling information in an information processing apparatus such as a PC means handling binary data.

The binary data refers to information indicating “0” or “1”, and such information indicating “0” or “1” is consecutively provided, so that binary data forms a specific meaning. For example, in a case where information indicating “hello” is handled as binary data, when “Shift JIS”, which is one of character codes, is used as an example, “h” corresponds to binary data “01101000”. Similarly, “e” corresponds to binary data “01100101”, “1” corresponds to binary data “01101100”, and “o” corresponds to binary data “01101111”. In other words, a character string “hello” can be represented as binary data “0110100001100101011011000110110001101111”. Conversely, if the binary data “0110100001100101011011000110110001101111” can be acquired, the character string “hello” can be acquired. Based on this principle, it can be seen that multiplexing can be achieved by embedding data in such a manner that “0” or “1” can be determined.

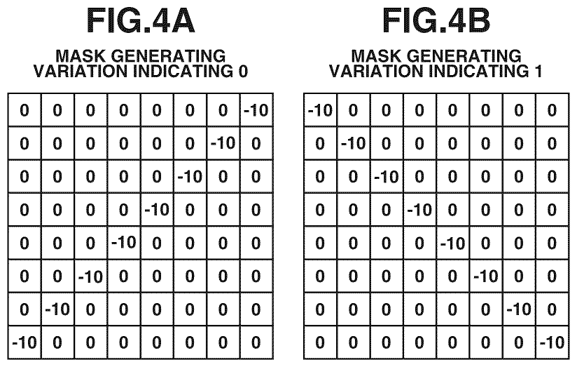

Here, in order to generate “0” or “1” in an image, two masks illustrated in FIGS. 4A and 4B will be considered.

Each mask includes 8 pixels×8 pixels, and adding the mask to an image, in other words, changing the density of print data, applies a pattern with periodicity to a region in the image that includes 8 pixels×8 pixels. Basically, a digital image is expressed in 8 bits per color and is assigned any value of the values from 0 to 255. Because a value falling outside the range cannot be used as image data, in a case where a calculation result of a pixel value is smaller than 0 or indicates a value equal to or larger than 256, generally, 0 or 255 is allocated to bring the value into an effective range. In the masks illustrated in FIGS. 4A and 4B, a change of −10 or 0 is added to a pixel value, but in a case where all values of image data in a mask region indicate 0, all values in the region indicate 0 instead of indicating −10 and 0. In this description, a digital image is assumed to be expressed in 8 bits per color. As a matter of course, a digital image can be expressed in the number of bits other than 8. In a case where a digital image is handled, an effective range is present irrespective of the number of bits, and a change that brings a value outside the range is not added.

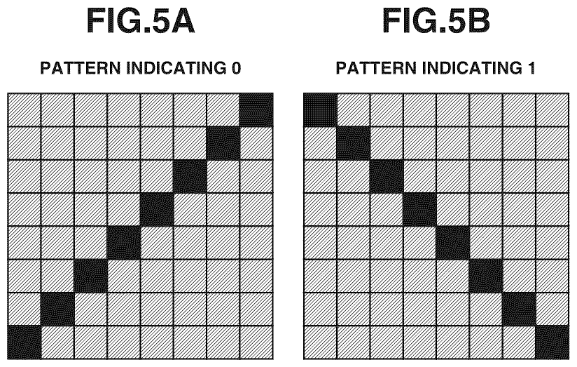

FIGS. 5A and 5B visually illustrate patterns to be applied to an image with the masks illustrated in FIGS. 4A and 4B. Positions of pixels with a value “−10” in the masks illustrated in FIGS. 4A and 4B are expressed by black, and positions of pixels with a value “0” are expressed by diagonal lines, and diagonals as illustrated in FIGS. 5A and 5B appear in the image.

Here, a pseudo-code of alternately applying the masks illustrated in FIGS. 4A and 4B to the entire image is given below.

| | |
|---|---|
| 01: | int i, j, k, l; |
| 02: | int width = 600, height = 900; |
| 03: | unsigned char *data = image data; |
| 04: | int **maskA = mask data; |
| 05: | bool isMaskA = true; |
| 06: | for(j = 0; j < height; j +=8){ |
| 07: | for(i = 0; i < width; I +=8){ |
| 08: | for(k = 0; k < 8; k++){ |
| 09: | for(l = 0; l < 8; l++){ |
| 10: | if(isMaskA == true){ |
| 11: | data[(i + k) + (j + l) * width] += maskA[k][l]; |
| 12: | } |
| 13: | } |
| 14: | } |
| 15: | } |
| 16: | } |

As described above, information embedding through multiplexing can be implemented with the above-described method.

In the present exemplary embodiment, the above-described embedding is performed only on B pixel values among RGB pixel values in FIG. 3. This is because, in a case where recording is performed in a blank part 304 using ink, Y ink has lower visibility than those of other inks, such as C ink, M ink, and K ink. To prevent embedment information from affecting original document information, it is desirable that the embedment information is not visually recognized as far as possible. Thus, by modulating B pixel values, control is performed in such a manner that the fluctuation of Y ink becomes the largest.

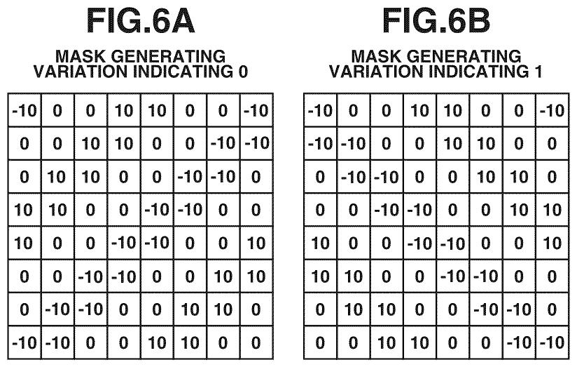

In the document 300 according to the present exemplary embodiment, the blank part 304 is wide enough, and a portion of the document 300 that excludes the character part 301, the rectangle drawing part 302, and the image part 303 corresponds to the blank part 304. Nevertheless, when information part 1602 is embedment information embedding into a part other than the blank part 304 sometimes fails to be properly performed using the masks illustrated in FIGS. 4A and 4B. For example, when the masks illustrated in FIGS. 4A and 4B are applied to a black solid image (R=0, G=0, B=0), a processing result similarly indicates a black solid image (R=0, G=0, B=0). Thus, in a case where information embedding is performed into a part other than the blank part 304, in particular, image part, masks illustrated in FIGS. 6A and 6B are desirable. Here, embedding processing into an information part excluding a marker part will be described as an example, but the same applies to the marker part.

In the masks illustrated in FIGS. 6A and 6B, changes of −10, 0, and +10 are added to pixel values. In this case, in a case where all values of image data in a mask region indicate 0, values in the region indicate −10, 0, and +10, and consequently become 0 and +10. In other words, by using a pattern of adding both of a change of increasing a pixel value and a change of decreasing a pixel value, it is possible to perform information embedding into all pixel values.

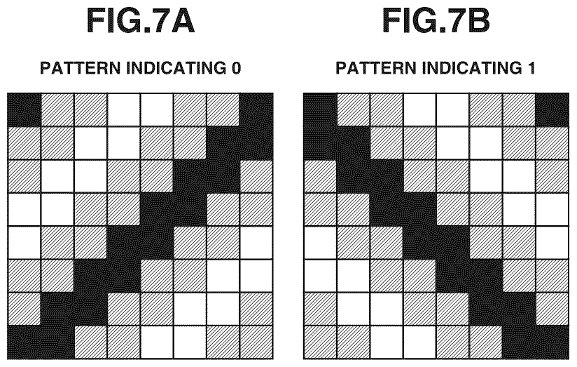

FIGS. 7A and 7B visually illustrate patterns to be applied to an image by the masks for an image part. Positions of pixels with a value “−10” in the masks illustrated in FIGS. 6A and 6B are expressed by black, positions of pixels with a value “0” are expressed by diagonal lines, and positions of pixels with a value “10” are expressed by white, and diagonals as illustrated in FIGS. 7A and 7B appear in the image.

Heretofore, it has been described that it is desirable to use the masks illustrated in FIGS. 6A and 6B, for the image part 303 in FIG. 3. Generally, it is considered that the blank part 304 is highly likely to account for a large portion of the character part 301 and the rectangle drawing part 302. Thus, the masks illustrated in FIGS. 4A and 4B are similarly used.

Nevertheless, depending on the color or the character thickness, the masks illustrated in FIGS. 6A and 6B are sometimes suitable for the character part 301 and the rectangle drawing part 302, and in some cases, an image drawing part is an image closely similar to the blank part 304. Thus, in order to execute more certain embedding, it is desirable to determine which of the masks illustrated in FIGS. 4A and 4B, and the masks illustrated in FIGS. 6A and 6B are suitably used, by, for example, acquiring a density histogram in each region.

Subsequently, the processing proceeds to step S205, in which the host PC 50 performs print image generation. In the print image generation, a known method may be used. In the present exemplary embodiment, an example of using the following method by the inkjet method will be described.

In step S205, four processes including color conversion, ink color separation, output characteristic conversion, and quantization are performed on each pixel of the multiplexed bitmap image including RGB pixel values that has been generated in step S204.

The color conversion is processing of performing conversion in such a manner that RGB information of the multiplexed bitmap image can be suitably recorded on the MFP main body 40. This process is performed because a color described in a draw command of the PDL is generally set to a color value with which the color can be suitably represented on a display, and in a case where a value is output to a printer without a change, an image in a different color is output.

Specifically, in order to calculate a combination of output pixel values (Rout, Gout, Bout) suitable for a combination of input pixel values (Rin, Gin, Bin), a three-dimensional look-up table is used. Ideally, since the input pixel values Rin, Gin, and Bin each have 256 levels of grayscale, the calculation can be implemented by preparing Table1 [256] [256] [256] [3] that includes a total of 16,777,216 (256×256×256) sets of output values, and setting

Rout=Table1[Rin][Gin][Bin][0];

Gout=Table1[Rin][Gin][Bin][1]; and

Bout=Table1[Rin][Gin][Bin][2].

Additionally, a contrivance of reducing a table size by reducing the number of grids of the look-up table from 256 grids to, for example, 16 grids and interpolating table values in a plurality of grids to determine output values may be applicable.

The ink color separation is processing of converting the output values Rout, Gout, and Bout of color conversion processing to output values of each ink color to be used in inkjet recording. In the present exemplary embodiment, a four-color inkjet printer that supports cyan, magenta, yellow, and black is intended to be used. Various implementation methods can be used also in the conversion. In the present exemplary embodiment, as in the color conversion processing, a combination of ink color pixel values (C, M, Y, K) suitable for a combination of output pixel values (Rout, Gout, Bout) is calculated. For this purpose, Table2 [256] [256] [256] [4] is used. In other words,

C=Table2[Rout][Gout][Bout][0],

M=Table2[Rout][Gout][Bout][1].

Y=Table2[Rout][Gout][Bout][2], and

K=Table2[Rout][Gout][Bout][3]

are set to implement the calculation. A known contrivance of reducing a table size may be used.

Here, desirable CMYK pixel values corresponding to pixel values (R=255, G=255, B=245) which is a result of modulating a blank part (R=255, G=255, B=255) in step S204 using the masks illustrated in FIGS. 4A and 4B are provided below. Specifically, it is desirable that only a Y pixel value has a value larger than 0, and the other CMK pixel values are close to 0 and smaller than the Y pixel value. This is because the visibility of an embedded image is desired to be made low as described in conjunction with step S204.

Subsequently, the output characteristic conversion converts the density of each ink color into the number of recorded dots. Specifically, for example, the density of 256 levels of grayscale for each color is converted to a recording dot rate of 1024 levels of grayscale for each color: Cout, Mout, Yout, and Kout. To achieve this, a one-dimensional lookup table Table3 [4] [256] is used which sets the appropriate recording dot rate for the density of each ink color and

Cout=Table3[0][C]

Mout=Table3[1][M]

Yout=Table3[2][Y]

Kout=Table3[3][K]

are set to implement the calculation. A contrivance of reducing a table size by reducing the number of grids of the look-up table from 256 grids to, for example, 16 grids and interpolating table values in a plurality of grids to determine output values may be applicable.

Subsequently, the quantization converts the recording dot rate Cout, Mout, Yout, or Kout for each ink color into On/Off of an actual recorded dot of each pixel. As a quantization method, any methods, such as an error diffusion method and a dither method, may be used. For example, using the dithering method,

$$Cdot = Halftone [ Cout ] [ x ] [ y ]$$

$$Mdot = Halftone [ Mout ] [ x ] [ y ]$$

$$Ydot = Halftone [ Yout ] [ x ] [ y ]$$

$$Kdot = Halftone [ Kout ] [ x ] [ y ]$$

are set so that On/Off of the recording dot for each ink color is achieved by comparing with a threshold corresponding to each pixel position. Here, a generation probability of each recorded dot becomes Cout/1023, Mout/1023, Yout/1023, and Kout/1023.

As described above, the print image generation in step S205 ends. The generated print image is transmitted to the MFP main body 40 of the inkjet method and print processing is executed.

Next, in step S206, the MFP main body 40 prints the print image generated in step S205.

Thus, a document with document data in which the document ID information is embedded can be printed onto a print medium. Here, from the patterns illustrated in FIGS. 5A and 5B, it can be seen that a pattern is drawn with a diagonal line of one pixel. The processing of thus generating a printed material in which document ID information is embedded into an image that is based on a rendering image will also be referred to as “multiplexing encode processing”.

### (Change Multiplexing Embedding Depending on Printing Method)

The processing of printing a multiplexed image by the inkjet method has been described so far. There is also processing of printing a multiplexed image with the electrophotographic method.

The color reproduction characteristics in printed documents differ between the inkjet method and the electrophotographic method. The electrophotographic method has better color reproduction and higher visibility on plain paper than that with the inkjet method. For this reason, in performing multiplexing with the electrophotographic method, if the processing is executed at an embedment strength equal to that of the inkjet method, a multiplexed pattern becomes prominent in a printed document. If an embedment strength is uniformly weakened to avoid this, in the inkjet method, in some cases, pattern formation becomes insufficient and reading accuracy degrades. In view of the foregoing, thereinafter, a method of changing a multiplexing strength at which information is to be embedded, depending on a printing method will be described.

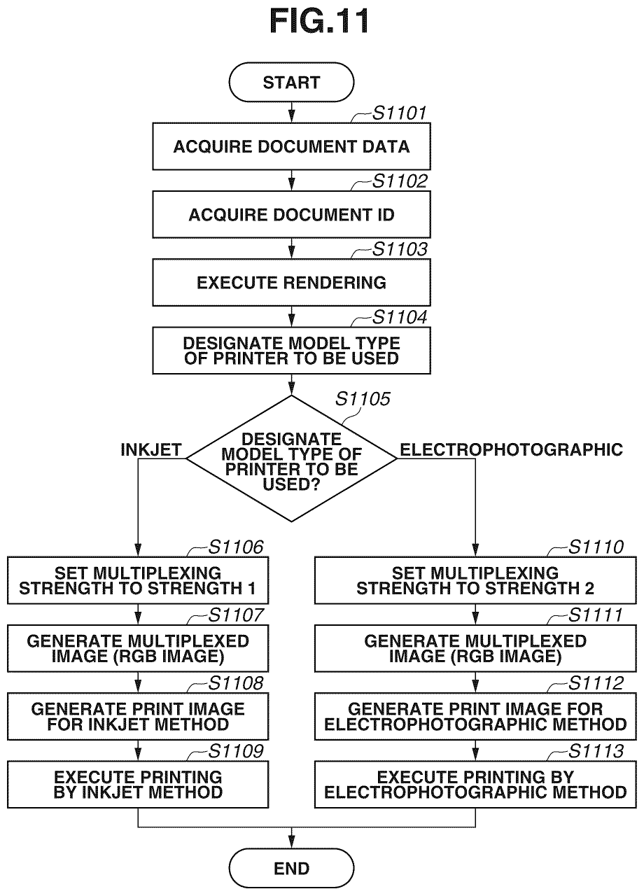

FIG. 11 is a flowchart illustrating processing of changing a multiplexing strength for embedment, depending on a printing method. A case where printing is executed by the MFP main body 40 of the inkjet method or the MFP main body 60 of the electrophotographic method will now be described.

In step S1101, the host PC 50 acquires document data. In the present exemplary embodiment, the host PC 50 connects to an external PC via the network I/F 507, and acquires document data by requesting the document data.

In step S1102, the host PC 50 acquires a document ID indicating the authenticity of the document data acquired in step S1101. The detailed operations is similar to that in step S202 of FIG. 2A.

In step S1103, the host PC 50 performs rendering processing of the document data acquired in step S1102. This is a step of executing each draw command described in the PDL, and forming a bitmap image constructed by color information of each pixel.

In step S1104, the host PC 50 designates a model type of a printer that is to print print data on which a document ID is multiplexed. Specifically, a printable printer model type list is generated based on model type information obtained through communication with printers, and displayed on a user interface (UI) displayed in response to the user transmitting a request for print processing. The user designates the model type of a printer that is to print print data, from the displayed model type list. Based on a printing machine designated by the user, information indicating a printing method is acquired. For the sake of explanatory convenience, only a printing machine employing the inkjet method or the electrophotographic method is connected in this example.

In step S1105, the host PC 50 switches processing depending on whether a printing method is the electrophotographic method or the inkjet method. In the case of the inkjet method (“INKJET” in step S1105), the processing proceeds to step S1106. In the case of the electrophotographic method (“ELECTROPHOTOGRAPHIC” in step S1105), the processing proceeds to step S1110.

In the operation in step S1106 and the subsequent operations, processing of printing a multiplexed image with the inkjet method will be described. In step S1106, the host PC 50 sets an embedment strength for a pattern to be multiplexed with the inkjet method. For the sake of explanatory convenience, a variation amount in generating an embedding pattern is changed as the embedment strength.

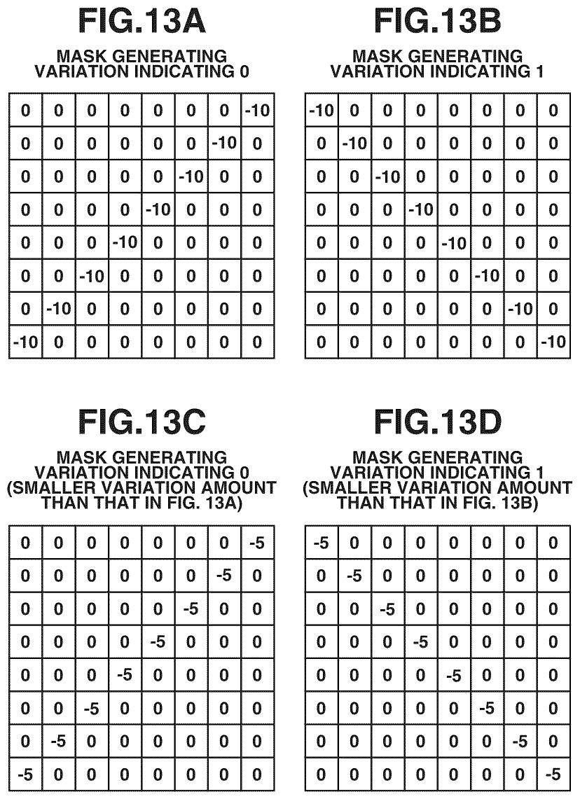

FIGS. 13A to 13D illustrate an embedment mask to be used in multiplexing, for each strength. A mask is switched based on binarized document ID information, so that there are masks indicating “0” and “1”. Variation amounts in FIGS. 13A and 13B are larger than those in FIGS. 13C and 13D. In other words, it is indicated that, in the masks illustrated in 13A and 13B, an embedment strength is stronger than those in the masks illustrated in FIGS. 13C and 13D.

In the electrophotographic method, the masks illustrated in FIGS. 13A and 13B that have a high embedment strength (strength 1) are used, and in the inkjet method, the masks illustrated in FIGS. 13C and 13D that have a low embedment strength (strength 2) are used. This is because the inkjet method provides higher visibility than that provided with the electrophotographic method especially in an edge portion due to bleeding. This will be described in detail.

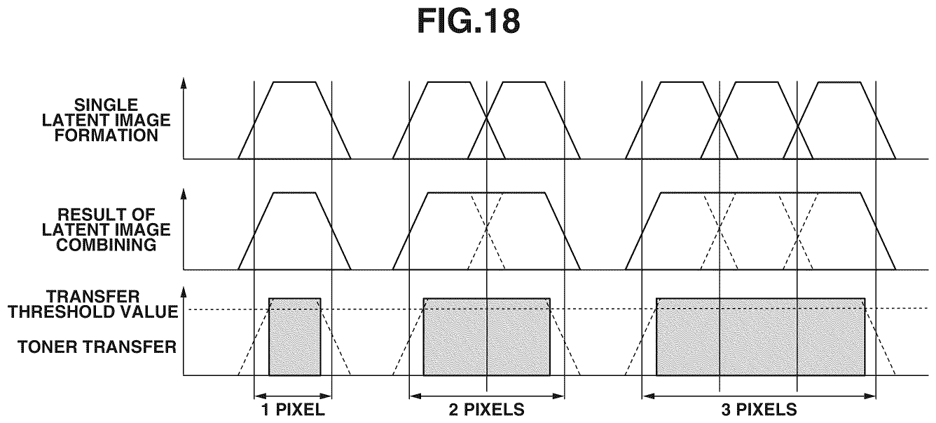

Japanese Patent No. 6452504 discusses processing of thickening a fine line portion in the electrophotographic method. FIG. 18 is a diagram schematically illustrating image formation with the electrophotographic method. For each number of pixels, a series of states including a state in which a single latent image is formed, next, a state in which a plurality of latent images are combined, and lastly, a state in which the latent images are transferred with toner are illustrated from top to bottom.

Initially, single latent image formation will be described. In the formation of a single latent image, edge bleeding occurs, where the strength decreases towards the edges of a pixel. For two or more pixels, pixels are arranged side by side so that that the ends overlap by the number of pixels.

Next, a state in which latent images are combined from the single latent image formation will be described. For two or more pixels, portions with edge bleeding overlap, so that, an edge bleeding is eliminated in a space between pixels, but edge bleedings remain at both ends of a plurality of combined pixels.

Next, toner transfer will be described. In the toner transfer, combined latent images are transferred to an intermediate transfer member. At the time, a portion with a strength stronger than a transfer threshold value, which is schematically indicated by a dotted line in FIG. 18, is transferred. That is, because an edge bleeding occurs at both ends (edge portions) of a plurality of combined pixels, images are transferred with the edge portions missing.

As described above, in the electrophotographic method, if, in forming a solid region, the latent image is formed to avoid waste, with edge bleeding being reflected, the edges are trimmed and fine lines becoming thinner. Thus, in the electrophotographic method, the visibility of fine lines decreases as compared with that in the inkjet method.

In step S1106, to acquire a multiplexing strength in the inkjet method, the masks illustrated in FIGS. 13C and 13D are used in the multiplexing processing.

In step S1107, the host PC 50 generates a multiplexed image by embedding the acquired document ID information into the bitmap image generated in step S1103, based on the multiplexing strength set in step S1106. The host PC 50 performs embedding processing on a B plane of the bitmap image at the set multiplexing strength. The detailed embedding processing is similar to the operations described in conjunction with step S204 of FIG. 2A. For masks to be used in embedding, the set masks (strength 2) are used.

The method of performing embedding processing on the B plane of the bitmap image has been described, but in a case where a printing machine is a monochrome printing machine that does not support color printing, embedding processing is performed on all RGB planes. Whether a printing machine is a monochrome printing machine may be determined based on acquired printing machine information.

In step S1108, the host PC 50 generates a print image for the inkjet method from the multiplexed image generated in step S1107. A detailed generation method is similar to that described in conjunction with step S205 of FIG. 2A. The host PC 50 transmits the generated print image to the MFP main body 40.

In step S1109, the host PC 50 transmits the print image for the inkjet method that has been generated in step S1108, to the MFP main body 40 of the inkjet method via the data transfer I/F 504 in the host PC 50, and the MFP main body 40 performs print processing. At this time, the data transfer I/F 504 switches a print image transmission destination based on the printer model type designated in step S1104.

In the operations in step S1110 and the subsequent steps, processing of printing a multiplexed image by the electrophotographic method will be described.

In step S1110, the host PC 50 sets an embedment strength of a pattern to be multiplexed with the electrophotographic method. Here, the masks illustrated in FIGS. 13C and 13D are used in the multiplexing processing.

In step S1111, the host PC 50 generates a multiplexed image by embedding the acquired document ID information into the bitmap image generated in step S1103, based on the multiplexing strength set in step S1110. The host PC 50 performs embedding processing on the B plane of the bitmap image at the set multiplexing strength. The set masks (strength 1) are used in embedding. The method of performing embedding processing on the B plane of the bitmap image has been described, but in a case where a printing machine is a monochrome printing machine not supporting color printing, embedding processing is performed on all RGB planes. Whether a printing machine is a monochrome printing machine may be determined based on acquired printing machine information.

In step S1112, the host PC 50 generates a print image for the electrophotographic method from the multiplexed image generated in step S1111. The host PC 50 performs processing as in the color conversion, the ink color separation, the output characteristic conversion processing, and the quantization processing which have been described in conjunction with step S205 of FIG. 2A. For Table1 to be used in the color conversion, Table2 to be used in the ink color separation, Table3 to be used in the output characteristic conversion, and the Halftone table to be used in the quantization, tables adapted to the MFP main body 60 are used to perform the processing. The host PC 50 transmits the generated print image to the MFP main body 60.

In step S1113, the host PC 50 transmits the print image for the electrophotographic method that has been generated in step S1112, to the MFP main body 60 of the electrophotographic method via the data transfer I/F 504 in the host PC 50, and the MFP main body 60 performs print processing. At this time, the data transfer I/F 504 switches a print image transmission destination based on the printer model type designated in step S1104.

Heretofore, processing of changing an embedment strength depending on a printing method has been described.

For the sake of explanatory convenience, a change of a multiplexing strength has been described using a mask change amount as an example, but a strength may be changed by switching the number of color planes on which embedding processing is to be performed, between the inkjet method and the electrophotographic method.

For example, by performing multiplexing only on a Y plane in the electrophotographic method and performing multiplexing not only on the B plane but also on an R plane in the inkjet method, it is possible to change a strength. By increasing a relative variation amount by combining a point where a mask amplitude is decreased, and a point where a mask amplitude is increased, an embedment strength may be changed. In such a case, setting is performed in such a manner that a relative variation amount in the inkjet method is smaller than that in the electrophotographic method. By changing the number of mask variation points, an embedment strength may be changed. In such a case, setting is performed in such a manner that the number of variation points in the inkjet method is smaller than that in the electrophotographic method.

In the present exemplary embodiment, an example of modulating B pixel values in RGB pixel values has been described, but embodiments of the present disclosure may use a method of modulating CMYK pixel values. In such a case, a blank part is Y=0, M=0, C=0, K=0, and modulation on the blank part is to be values of +. Thus, it is sufficient that signs of modulated values illustrated in FIGS. 4A and 4B and 6A and 6B are inverted. More specifically, it is sufficient that a modulated value of −10 is changed to +10 and a modulated value of +10 is changed to −10.

Performing modulation on CMYK pixel values provides high control in limiting ink to be applied to a blank part only to Y ink while performing modulation on RGB pixel values provides high control in reducing a hue variation in performing embedding into an image part. Thus, it is desirable to select a suitable modulation method in accordance with a ratio between a blank part, a character region, and an image region in a document.

In a case where a printing method of a connected printing apparatus is a printing method other than predetermined methods (in the present exemplary embodiment, neither the inkjet method nor the electrophotographic method), it is desirable to perform processing according to the following procedure.

Procedure 1: In a case where a correction method dedicated for the printing method such as a modulation strength is set, the setting is to be used.

Procedure 2: In a case where there is no dedicated setting, if an alternative setting is set, the setting is to be used.

For example, for a thermal printer system that uses a heat-sensitive sheet on which color is changed by heat, there is a high possibility that an embedding setting of the electrophotographic method can be used as an alternative setting. Similarly, also for a heat transfer system of using an ink ribbon in place of heat-sensitive sheets, there is a high possibility that an embedding setting of the electrophotographic method can be used. In a case where neither a printing apparatus employing the inkjet method nor a printing apparatus employing the electrophotographic method is connected, and a thermal printing apparatus or a heat transfer system printing apparatus is connected, the same processing as that with the electrophotographic method is applied.

Procedure 3: In a case where neither a dedicated setting nor an alternatively setting is set, multiplexing processing is not performed.

Subsequently, a document ID information extraction processing will be described.

In step S211 of FIG. 2B, a printed material into which document ID information is multiplexing-encoded is read.

Initially, a print document is set on a scanner apparatus and in step S211, document reading is performed. Specifically, a scanner device is controlled to emit LED light to the document, and reflected light is converted into analog electric signals by an image sensor such as a CCD image sensor that faces each pixel.

Next, in step S212, the analog electric signals are digitalized, and digital RGB values are input. In the bitmap acquisition processing, a known method may be used, but in the present exemplary embodiment, an example of using the following method will be described.

In step S212, four processes including modulation transfer function (MTF) correction, input correction, shading correction, and color conversion are performed on each pixel of the bitmap image including RGB pixel values that has been acquired in step S211.

The MTF correction corrects resolution among the scanner's reading performance. Specifically, scanner reading results in blurred images due to a shift from a focus position and performance limitations on a lens itself, so that some degree of restoration is performed using filtering processes. In practice, applying overly strong enhancement processing to achieve complete restoration can lead to image artifacts, such as blown highlights, image noise, and the enhancement of dust pixels, making these more noticeable. Thus, the design is to balance image quality improvement with these artifacts. To simplify the explanation, an example of an edge enhancement filter that multiplies the central part of the image by 5 and the pixel values above, below, left, and right by −1 is provided below.

$${R}^{′} [ x ] [ y ] = R [ x ] [ y ] \times 5 - R [ x - 1 ] [ y ] - R [ x + 1 ] [ y ] - R [ x ] [ y - 1 ] - R [ x ] [ y + 1 ]$$

$${G}^{′} [ x ] [ y ] = G [ x ] [ y ] \times 5 - G [ x - 1 ] [ y ] - G [ x + 1 ] [ y ] - G [ x ] [ y - 1 ] - G [ x ] [ y + 1 ]$$

$${B}^{′} [ x ] [ y ] = B [ x ] [ y ] \times 5 - B [ x - 1 ] [ y ] - B [ x + 1 ] [ y ] - B [ x ] [ y - 1 ] - B [ x ] [ y + 1 ]$$

The input correction is processing of converting output values from a CCD image sensor that originally indicate a photon amount, into brightness suitable for the sensitivity of human eyes. Specifically, for example, R′G′B′ signals with 4096 levels of grayscale for each color are converted into color strength values R″, G″, and B″ with 1024 levels of grayscale for each color. To achieve this, a one-dimensional lookup table, Table4 [4] [4096], is used which sets the appropriate recording dot rate for the density of each ink color, and

R″=Table4[0][R′]

G″=Table4[1][G′]

B″=Table4[2][B′]

are set to implement the calculation. A known contrivance of reducing a table size by reducing the number of grids of the look-up table from 4096 grids to, for example, 256 grids and interpolating table values in a plurality of grids to determine output values may be used.

The shading correction is processing of reducing color and density unevenness caused by differences in reading sensitivity at each pixel position, which arise from manufacturing variations and assembly inconsistencies in the lenses, LEDs, and CCD sensors that are included in the scanner device. Specifically, for example, R″G″B″ signals with 1024 levels of grayscale for each color are converted into color strength values R′″, G′″, and B′″ with 256 levels of grayscale for each color. To achieve this, a one-dimensional lookup table for density conversion, Table5 [x] [3] [1024], for each X pixel position in the direction in which the scanner lens is arranged (X direction), is used, and

$${R}^{″′} = Table 5 [ x ] [ 0 ] [ {R}^{″} ]$$

$${G}^{″′} = Table 5 [ x ] [ 1 ] [ {G}^{″} ]$$

$${B}^{″′} = Table 5 [ x ] [ 2 ] [ {B}^{″} ]$$

are set to implement the calculation. A known contrivance of reducing a table size by reducing the number of grids of the look-up table from 1024 grids to, for example, 256 grids and interpolating table values in a plurality of grids to determine output values may be used.

Lastly, the color conversion processing is performed. This is performed to convert the R′″, G′″, and B′″ values calculated so far, into Rout, Gout, and Bout values suitable for being displayed on a display because the R′″, G′″, and B′″ values are specific to a scanner device, which is the reverse in printing.

To achieve this, as in color conversion in printing, since the input values R′″, G′″, and B′″ each have 256 levels of grayscale, the calculation can be implemented by preparing Table6 [256] [256] [256] [3] which is a table including 16,777,216 (256×256×256) sets in total of output values, and setting

Rout=Table1[R′″][G′″][B′″][0]

Gout=Table1[R′″][G′″][B′″][1]

Bout=Table1 [R′″] [G′″] [B′″] [2]. A contrivance of reducing a table size by reducing the number of grids of the look-up table from 256 grids to, for example, 16 grids and interpolating table values in a plurality of grids to determine output values may be used.

Through the above-described processing, the bitmap acquisition in step S212 ends.

Subsequently, in step S213, multiplexed document ID information is extracted.

As an extraction method, for each unit including 8 pixels×8 pixels, whether either pattern in FIG. 5A or 5B is recorded is determined, and information indicating 0 or 1 is extracted. By repeating this, the multiplexed information is decoded.

Hereinafter, the overview of multiplexed information decoding will be described.

Initially, a position in the acquired bitmap image where multiplexed information is embedded is detected. More specifically, by analyzing space frequency characteristics of each region in the bitmap image that includes 8 pixels×8 pixels, an embedded position is detected.

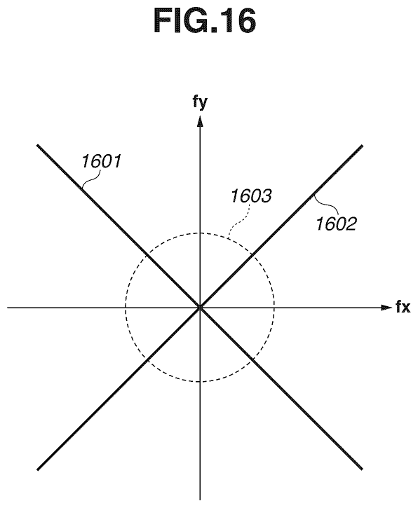

FIG. 16 is a diagram illustrating space frequency characteristics of a pattern used in embedding. The horizontal axis represents a horizontal frequency and the vertical axis represents a vertical frequency, and a region farther from an origin becomes a higher frequency region. In the present exemplary embodiment, as illustrated in FIGS. 4A and 4B, two patterns are embedded in an image. In an embedding example, addition and subtraction of 10 are performed on B components of RGB. With this configuration, the pattern illustrated in FIG. 4A generates a large power spectrum on a line 1601. Similarly, the pattern illustrated in FIG. 4B generates a large power spectrum on a line 1602.

Thus, by detecting the power spectrum, data extraction of “0” or “1” is performed. By performing edge detection as preprocessing of detection, it is also possible to enhance the power spectrum.

In the data extraction by frequency analysis, an analysis area is to be accurately clipped from image data, and thus, processing of correcting a coordinate positional shift is performed. For example, there is a method of clipping a region including 8 pixels×8 pixels from an image and frequency analysis is performed, shifting by 1 pixel both vertically and horizontally, repeating this process 64 times (8 px horizontally and 8 px vertically). The position where the spectrum is strongest is then used as a clipping reference position.

Extraction of multiplexed information is performed after position detection is completed, thus obtaining an embedded numerical sequence of “0” and “1”.

In the present exemplary embodiment, as described above in conjunction with step S204, multiplexed information to be embedded in advance is treated as text document data, with the character codes converted to numerical values using “Shift JIS”.

In a one-byte code (half-width characters) of the Shift JIS, as described above, “h” corresponds to binary data “01101000”, “e” corresponds to binary data “01100101”, “l” corresponds to binary data “01101100”, and “o” corresponds to binary data “01101111”.

Thus, if a number string of extracted added information is “0110100001100101011011000110110001101111”, a character string becomes “hello”.

In practice, document ID information embedded in step S204 as added information is extracted, and processing ends.

Subsequently, in step S214, it is determined whether the document ID information has been extracted.

In a case where the document ID information has been extracted (YES in step S214), the processing proceeds to step S215. In a case where the document ID information has not been extracted (NO in step S214), the processing proceeds to step S220, in which print data generation that is based on a scanned image is performed.

In a case where the document ID information has not been extracted (NO in step S214), the following two possibilities can be considered.
Possibility 1: a case where document ID information has not been embedded in advance in a document scanned in step S211
Possibility 2: a case where document ID information has been embedded, but embedded data has failed to be read due to a dirt on a printed material or a large amount of information is added afterward by handwriting

In the case of Possibility 1, the processing can directly proceed to step S220. Nevertheless, in the case of Possibility 2, a user may be notified that “a user has tried to copy an authentic document in which a document Id is embedded”. This allows a user to be notified that the user has attempted to create an “unauthentic copy” as a “copy of an authentic document”, giving the user the opportunity to choose to stop the copying process or take other actions. In the present exemplary embodiment, the determination of Possibility 2 is possible in a case where information equal to or larger than 1 bit and equal to or smaller than 31 bits is extracted from the 32-bit document ID information in step S213. Nevertheless, in view of the possibility that a similar image is accidentally present only by one pattern, the determination of Possibility 2 is desirably made in a case where information equal to or larger than at least 16 bits (half) and equal to or smaller than 31 bits is extracted.

Subsequently, the document ID information extracted in step S215 is verified.

As in step S202, the host PC 50 requests an external PC via the network I/F 507 to verify whether the extracted document ID information is authentic document ID information. At this time, by employing a block-chain-like configuration, where document data and document IDs are managed in a plurality of external PCs, it is possible to reduce the possibility of the document IDs themselves being tampered with.

Next, in step S216, as a verification result of the document ID information, it is determined whether a document ID is a valid document ID. In a case where it is determined that a document ID is a valid document ID (YES in step S216), the processing proceeds to step S217. In a case where it is determined that a document ID is not a valid document ID (NO in step S216), the processing proceeds to step S220, in which print data generation that is based on a scanned image is performed.

Also in a case where it is determined that a document ID is not a valid document ID (NO in step S216), a user may be notified that “a user has attempted to copy an unauthentic document with an invalid document ID”. This configuration gives the user the opportunity to choose to stop the copying process or take other actions.

Next, in step S217, document tamper check is performed. In order to perform tamper check, initially, the host PC 50 acquires document data that is based on document ID information from an external PC via the network I/F 507. Next, as in step S203, the host PC 50 performs rendering processing of the document data. The host PC 50 determines whether tampering has occurred, by comparing the rendering result and a scan result.

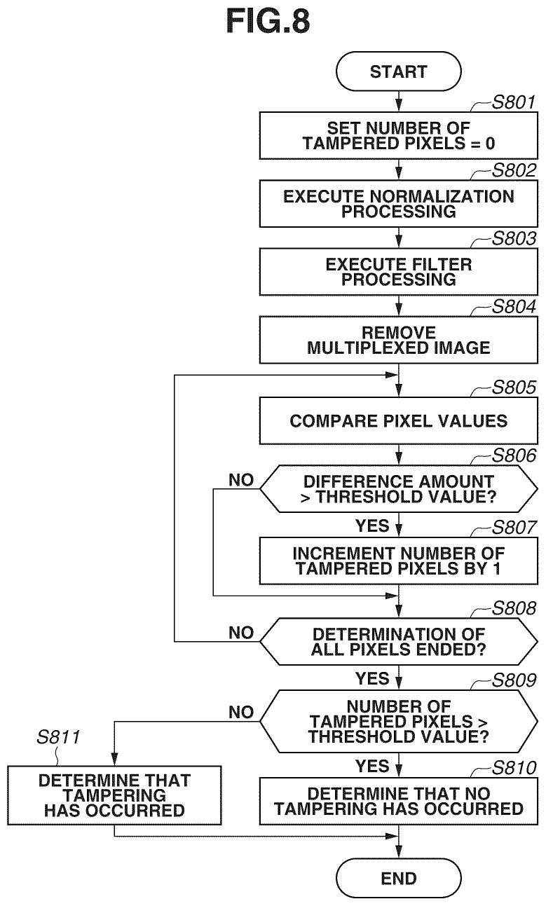

FIG. 8 illustrates processing of determining whether document tampering has occurred.

In step S801, initialization is performed and the number of tampered pixels=0 is initially set.

In step S802, normalization of a scanned bitmap image is performed. This is because dynamic ranges of the bitmap image and a rendering image are different, and it is inappropriate to compare these as-is.

For example, the brightest portion in the bitmap image generally has the color of document paper, and has a value of a certain density in principle. In contrast, the brightest portion in the rendering image corresponds a pixel with R=255, G=255, B=255, so that brightest colors of both images are originally different.

Similarly, the darkest portion in the bitmap image generally corresponds to a black ink or black toner, and has a value with certain brightens attributed to reflected light in principle. In contrast, the darkest portion in the rendering image corresponds a pixel with R=0, G=0, B=0, so that darkest colors of both images are originally different.

Regarding the color tone of color documents, the saturation of the sharpest red color printable onto a document is lower as compared with the sharpest red color (R=255, G=0, B=0) on the rendering image.

Thus, for pixel values R, G, and B of the bitmap image,

$$Rnorm = ( R - Rd ) / ( Rw - Rd ) \times 255 ;$$

$$Gnorm = ( G - Gd ) / ( Gw - Gd ) \times 255 ;$$

and

Bnorm=(B−Bd)/(Bw−Bd)×255 are set. Thus, the brightest color of the bitmap image can be set to R=255, G=255, B=255, and the darkest color of the bitmap image can be set to R=0, G=0, B=0.

Next, in step S803, filter processing is performed. This is because, while the above-described MTF correction is edge enhancement within a visually desirable range, it is desirable to execute processing of filtering with increased edge enhancement for image comparison.

Next, in step S804, a multiplexed image is removed. This is performed because there is a difference between original document data to which data is originally desired to be restored, and a print document due to the generation of a multiplexed image in step S203 of FIG. 2A, and thus, the difference is to be eliminated as far as possible. Specifically, embedded data in image data has been extracted from read multiplexed data, by conversely subtracting the embedded data, it is possible to bring read image data closer to document data before embedding. In the present exemplary embodiment, this can be implemented by further embedding a value obtained by multiplying a mask value of embedding 0 and 1 illustrated in FIGS. 4A, 4B, 6A, and 6B, by −1, into a read image.

Next, in step S805, image comparison is performed. In the present exemplary embodiment, in step S217, an image A rendered based on the document data and a multiplexed removed image B corrected in step S503 are compared for each pixel.

$$Δ R = \vert R [ x ] [ y ] of image A - R [ x ] [ y ] of image B \vert$$

$$Δ G = \vert G [ x ] [ y ] of image A - G [ x ] [ y ] of image B \vert$$

$$Δ B = \vert B [ x ] [ y ] of image A - B [ x ] [ y ] of image B \vert$$

Next, in step S806, it is determined whether a pixel value difference amount exceeds a threshold value. In the present exemplary embodiment, threshold values Rth, Gth, and Bth are provided for the respective channels R, G, and B, and determination is made as follows:

| If ((ΔR > Rth)\|\| | |
|---|---|
| (ΔG > Gth)\|\| | |
| (ΔB > Bth) ){“Yes”} | |
| Else | {“No”}. |

In the present exemplary embodiment, Rth=Gth=Bth=64 is set, but it is desirable that the threshold values are appropriately set in accordance with the characteristics of a reading device or a recording device.

In a case where it is determined whether a pixel value difference amount does not exceed a threshold value (NO in step S806), the processing proceeds to step S808. In a case where it is determined whether a pixel value difference amount exceeds a threshold value (YES in step S806), the processing proceeds to step S807.

Next, in step S807, the number of tampered pixels is incremented by +1, and the processing proceeds to step S808.

Next, in step S808, it is determined whether determination on all pixels has been completed.

In a case where it is determined that determination on all pixels has not been completed (NO in step S808), the processing returns to step S805 and the processing is continued. In a case where it is determined that determination on all pixels has been completed (YES in step S808), the processing proceeds to step S809.

Next, in step S809, it is determined whether the number of tampered pixels exceeds a threshold value. In a case where it is determined that the number of tampered pixels exceeds a threshold value (YES in step S809), the processing proceeds to step S810. In step S810, it is determined that no tampering has occurred, and the processing proceeds to step S218.

In a case where it is determined that the number of tampered pixels does not exceed a threshold value (NO in step S809), the processing proceeds to step S811. In step S811, it is determined that tampering has occurred, and the processing proceeds to step S218.

In the present exemplary embodiment, on the assumption of a case where a dirt of a scanned image is mixed, a threshold for the number of tampered pixels is set to 3% of the number of all pixels, but the threshold value may be appropriately set in accordance with the characteristics of a printing device and a reading device.

Next, in step S218, it is determined whether a read image is an untampered image. In a case where it is determined that a read image is an untampered image (YES in step S218), the processing proceeds to step S219. In a case where it is determined that a read image is not an untampered image (NO in step S218), the processing proceeds to step S220, in which print data generation that is based on a scanned image is performed.

Also in a case where it is determined that a read image is not an untampered image (NO in step S218), a user may be notified that “the user has attempted to copy a tampered authentic document”. This configuration gives the user the opportunity to choose to stop the copying process or take other actions.

<Superimpose Extracted Document ID onto Original Document Data>

Next, in step S219, information indicating replication is added to the image. The addition of information indicating authenticity is performed through the following procedure. As in step S217, document data that is based on document ID information is acquired. As in step S203, acquired document data is rendered. As in step S204, multiplexing processing is executed on a rendered text image, and a multiplexed image is generated. As document ID information to be embedded at this time, a document ID extracted in step S213 is used. Through such a procedure, information indicating authenticity is added to the image.

In a case where text data cannot be used, a method of using a scanned image may be employed.

### <Enhancement of Embedding Pattern In Scanned Image>

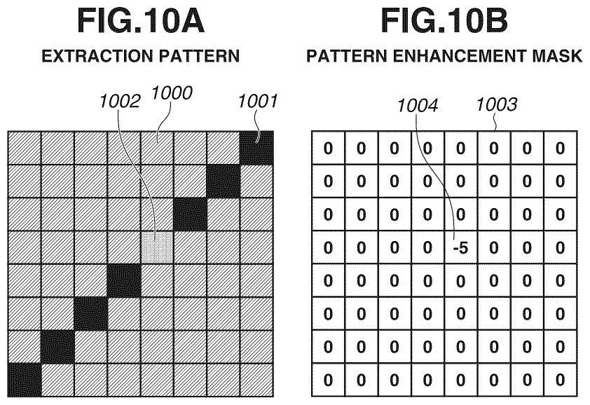

In the bitmap image acquired in step S212, an embedding pattern degrades through printing and scanning. FIGS. 10A and 10B schematically illustrate a degradation in pattern. An extracted pattern 1000 includes a part 1001 of an embedding pattern. A part 1002 of the embedding pattern has a small difference in pixel value from a part other than an embedding pattern, as compared with the part 1001, and has a weak embedment strength.

In a case where a scanned image is an image like the embedding pattern 1000, it can be determined that an extracted embedding pattern is weak. Also a case where error correction is executed at the time of document ID extraction in step S213, and an error has been corrected, it can be similarly determined that a pattern is weak.

In a case where it is determined that an embedding pattern is weak, processing of enhancing the embedding pattern in a scanned image is performed. An enhancement mask 1003 illustrated in FIGS. 10A and 10B is a mask generated for pixels with a weak embedding pattern based on the mask illustrated in FIG. 4A. In a part 1004 of the mask, a strength to be added to a pixels with a weak embedding pattern is set. The strength may be set based on a difference between the part 1001 and the part 1002, or may be uniformly set using a predetermined value.

As in step S204, multiplexing processing is executed using the extracted document ID. At this time, as for a region where an embedding pattern is determined to be weak, multiplexing processing is executed by adding an enhancement mask to the masks generating variations that are illustrated in FIGS. 4A and 4B. Aside from this, by generating a pattern based on a generated enhancement mask, and applying the enhancement mask to a scanned image, it is possible to enhance an embedded pattern.

### <Newly Superimpose Embedding Pattern by Reducing Embedding Pattern in Scanned Image>

Multiplexing processing may be executed again by reducing an embedding pattern in a scanned image.

As a reduction method for an embedding pattern, a smoothing filter with a predetermined size is applied to a scanned image. A filter size may be set based on the size of an embedding pattern (8 pixels×8 pixels in this example). An inverse filter may be calculated from an embedding pattern. In a case where a pattern embedding region is a blank region, processing of changing a pixel value also in blank paper may be performed by background removal. In a case where an embedding pattern is added to a specific color plane, the above-described reduction processing may be executed only on the specific color.

When an embedding pattern in a scanned image is reduced, in order to commonalize processing on a print document between the inkjet method and the electrophotographic method, embedment strengths for the respective method are to be the same on a sheet plane. For this reason, an embedment strength is to be changed depending on the above-described printing method.

As in step S204, multiplexing processing of embedding an extracted document ID into an image in which an embedding pattern is reduced is executed.

Next, in step S220, a print image is generated and in step S221, printing is performed. Specific processing is similar to the operations in steps S205 and S206, the description is omitted.

According to the above-described configuration, in a system that can use a printing method other than the inkjet method or the inkjet method for recording, a multiplexing strength at which information is embedded is changed depending on the printing method. It is accordingly possible to keep balance between robustness and image quality in reading performance in each printing method.

### Modified Example of First Exemplary Embodiment

In the first exemplary embodiment, an example of embedding information for each unit of 8 pixels×8 pixels has been described with reference to FIGS. 4A, 4B, 6A, and 6B.

This is an example in which an image is embedded into a high frequency region so that the embedment is less visually recognizable by the user. The beneficial effects of embodiments of the present disclosure are not limited to multiplexing in the high frequency region, and are also produced through any multiplexing methods.

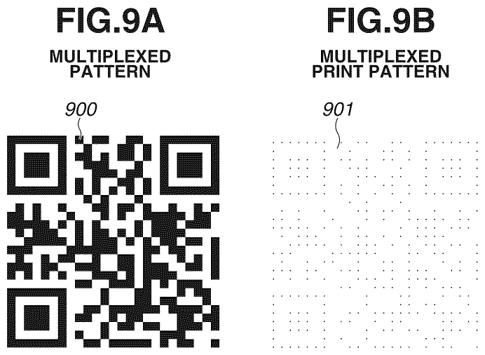

FIGS. 9A and 9B illustrate another example of a multiplexing method. FIG. 9A illustrates a pattern example of a quick response (QR) code (registered trademark). In this example, document ID information is converted into a QR code and the QR code is multiplexed on a printed material in a less visually-recognizable manner. FIG. 9B illustrates an actual print pattern, and a illustrates a pattern of recording only one dot for each unit of 8 pixels×8 pixels. A dot 900 corresponding to a black pixel in FIG. 9A corresponds to one dot 901 in FIG. 9B. In FIG. 9B, a dot is not formed at the position corresponding to the black pixel in FIG. 9A.

With this configuration, it is possible to form a less visually-recognizable multiplexed pattern on a recording sheet. Specifically, in step S203 of FIG. 2A, document ID information is converted into a QR code as illustrated in FIG. 9A, and the QR code is superimposed on a rendering image as print data as illustrated in FIG. 9B, which is a group of separated dots.

Additionally, yellow ink is the least visible, using yellow ink or yellow toner to form the separation dots in the pattern shown in FIG. 9B allows for a less visually-recognizable multiplexed pattern on the recording sheet.

In the case of this multiplexing method, it is determined whether a yellow dot is recorded in a read bitmap image for each unit of 8 pixels×8 pixels, a QR code pattern equivalent to the pattern illustrated in FIG. 9A is extracted, and the QR code pattern is decoded, thus executing the document ID information extraction in step S213.

As another multiplexing example, threshold value modulation is performed at the time of quantization processing during the print image generation processing in step S205 of FIG. 2A (Japanese Patent No. 4187749) to perform multiplexing. This method may be used.

A second exemplary embodiment of the present disclosure will be described below. While the method of changing a multiplexing strength has been described in the first exemplary embodiment, depending on the printing method, it is possible to make information unnoticeable by multiplexing the information onto a specific ink color. Thus, in the present exemplary embodiment, a method of changing a color plane of an image into which text authentic information is to be embedded, depending on the printing method will be described.

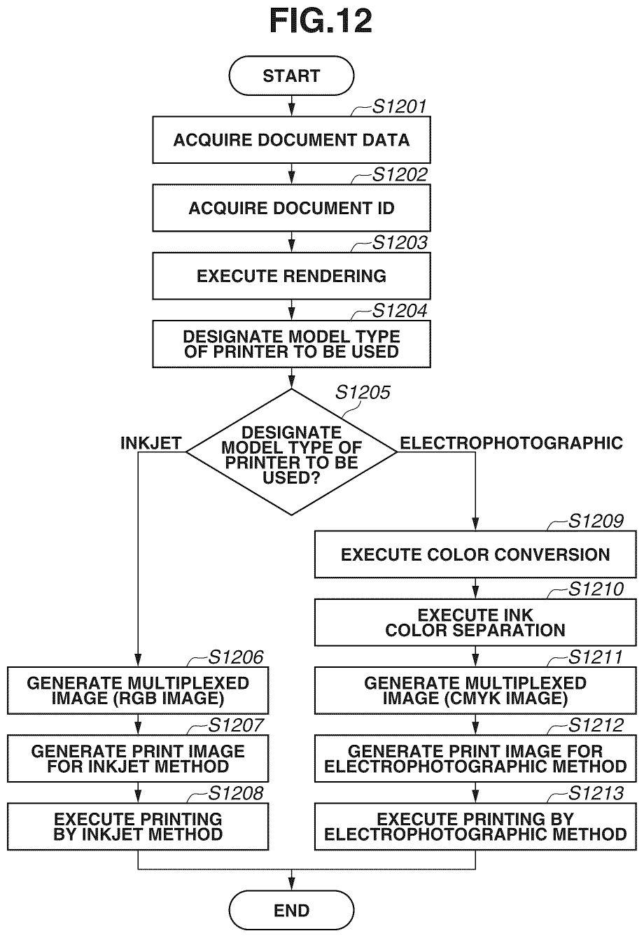

FIG. 12 is a flowchart illustrating processing of changing, depending on the printing method, a color plane of an image to be subjected to multiplexing. A case where printing is executed by the MFP main body 40 of the inkjet method or the MFP main body 60 of the electrophotographic method will be described.

The operations in steps S1201 to S1204 are similar to those in steps S1101 to S1104 of FIG. 11, and thus, descriptions thereof are omitted.

In step S1205, the host PC 50 switches the subsequent operations depending on whether the printing method acquired in step S1204 is the electrophotographic method or the inkjet method. In the case of the inkjet method (“INKJET” in step S1205), the processing proceeds to step S1206. In the case of the electrophotographic method (“ELECTROPHOTOGRAPHIC” in step S1205), the processing proceeds to step S1209.

In the operations in step S1206 and the subsequent steps, processing of printing a multiplexed image by the inkjet method will be described. In step S1206, the host PC 50 embeds the document ID information acquired in step S1202, into the bitmap image rendered in step S1203, thus generating a multiplexed image. The rendered bitmap image is represented by an RGB space, and embedding processing is executed on the B plane. The detailed embedding processing is similar to that in conjunction with step S204 of FIG. 2A. Here, the method of performing embedding processing on the B plane of the bitmap image has been described, but in a case where a printing machine is a monochrome printing machine that does not support color printing, embedding processing is performed on all RGB planes. Whether a printing machine is a monochrome printing machine may be determined based on acquired printing machine information.

In step S1207, the host PC 50 generates a print image for the inkjet from the multiplexed image generated in step S1206. A detailed generation method is similar to the operation described in conjunction with step S205 of FIG. 2A. The host PC 50 transmits the generated print image to the MFP main body 40.

In step S1208, the host PC 50 transmits the print image for the inkjet that has been generated in step S1207, to the MFP main body 40 employing the inkjet method via the data transfer I/F 504 in the host PC 50, and the MFP main body 40 performs print processing. At this time, the data transfer I/F 504 switches a print image transmission destination based on the printer model type designated in step S1204.

In the operations in step S1209 and the subsequent steps, the processing of printing a multiplexed image with the electrophotographic method will be described. In step S1209, the host PC 50 executes color conversion on the bitmap image generated in step S1203. The color conversion is a process of converting RGB information of the bitmap image in such a manner that so that it can be optimally printed by the MFP main body 60. The detailed conversion method is that similar to the color conversion described in conjunction with step S205 of FIG. 2A, and the color conversion is performed using Table1 adapted to the MFP main body 60.

In step S1210, the host PC 50 performs ink color separation on the color-converted image generated in step S1209, corresponding to the number of ink colors used in the MFP main body 60. In this example, the host PC 50 separates ink color into four colors corresponding to cyan, magenta, yellow, and black. In the present exemplary embodiment, the MFP main body 60 is assumed to employ a four-color electrophotographic method that supports printing in cyan, magenta, yellow, and black. The detailed processing of the ink color separation is similar to the ink color separation described in conjunction with step S205 of FIG. 2A, and the ink color separation is performed using Table2 adapted to the MFP main body 60.

In step S1211, the host PC 50 embeds the document ID information acquired in step S1202, into the ink-color-separated image generated in step S1210, thus generating a multiplexed image. In this example, the host PC 50 executes embedding processing on the ink-color-separated Y plane. The acquired document ID information is held as binary data, and thus, an embedment mask is switched based on bit information thereof. The two masks illustrated in FIGS. 4A and 4B are used as patterns. The mask is switched based on the bit information of the document ID information, and a target pixel value of the Y plane is changed in accordance with the modulation in the mask, so that the document ID information is superimposed on the image. The method of performing multiplexing processing on the Y plane has been described, but in a case where ink other than the yellow ink is used in an image region on which multiplexing processing is to be performed, the multiplexing processing may be performed on a plane other than the Y plane. The method of performing embedding processing on the Y plane has been described, but in a case where a printing machine is a monochrome printing machine not supporting color printing, embedding processing is performed for black ink. Whether a printing machine is a monochrome printing machine may be determined based on acquired printing machine information.

In step S1212, the host PC 50 generates a print image for the electrophotographic method from the multiplexed image generated in step S1211. The host PC 50 performs processing similar to the output characteristic conversion processing and the quantization processing described in conjunction with step S205 of FIG. 2A. The host PC 50 performs the processing using tables adapted to the MFP main body 60, for the Table3 to be used in the output characteristic conversion, and the Halftone table to be used in the quantization. The host PC 50 transmits the generated print image to the MFP main body 60.

In step S1213, the host PC 50 transmits the print image for the electrophotographic method that has been generated in step S1212, to the MFP main body 60 of the electrophotographic method via the data transfer I/F 504 in the host PC 50, and the MFP main body 60 performs print processing. At this time, the data transfer I/F 504 switches a print image transmission destination based on the printer model type designated in step S1204.

Heretofore, the processing of changing a color plane of the image onto which information is to be multiplexed, depending on the printer model type, has been described.

Beneficial effects produced by the present exemplary embodiment will be described below. Embedment into the B plane is performed for the inkjet method and embedment into the Y plane is performed for the electrophotographic method, so that it is possible to achieve an unnoticeable embedment in each printing method.

Furthermore, the following beneficial effects are also produced. In the inkjet method, a wide variety of ink including dark ink, light ink, and spot color ink is used depending on the printer model type. Either dark ink, light ink, or both may be used depending on the gradation to be expressed. Thus, in a case where multiplexing is performed only on a specific plane, such as a case where multiplexing processing is performed on a dark ink color plane, for example, no dot is ejected depending on the gradation. Consequently, a multiplexed pattern fails to be formed, and extraction accuracy might degrade. In contrast, with the electrophotographic method, because ink does not bleed on a paper surface, increased visibility is provided as compared with the inkjet method. Therefore, embedding with highly visible ink colors other than yellow will provide a noticeable result. In this embodiment, the plane to be multiplexed according to the printing method is changed, so that the issue of multiple ink colors in the inkjet method described above is addressed and the image quality degradation caused by multiplexing in the electrophotographic method is reduced.

A third exemplary embodiment of the present disclosure will be described below. In the first and second exemplary embodiments, the methods of changing a multiplexing strength and a color plane into which information is embedded have been described, but depending on the printing method, light from a light source is strongly reflected in a dark portion, and the image quality of a read image sometimes degrades. For this reason, in the present exemplary embodiment, a method of changing an image density for embedment, depending on the printing method will be described.

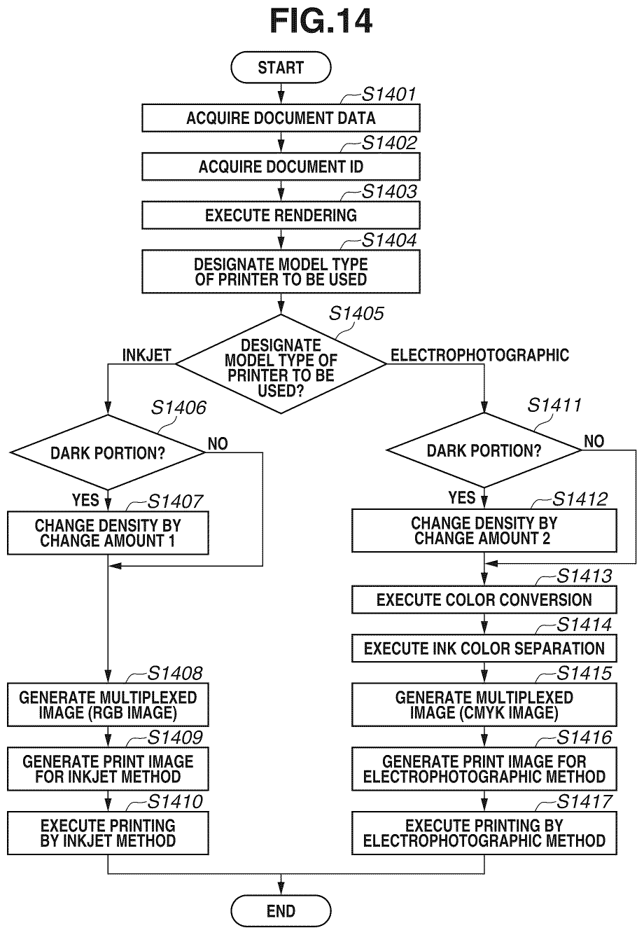

FIG. 14 is a flowchart illustrating processing of changing an image density for embedment, depending on the printing method. A case where printing is executed by the MFP main body 40 of the inkjet method or the MFP main body 60 of the electrophotographic method will be described.

The operations in steps S1401 to S1404 are similar to those in steps S1101 to S1104 of FIG. 11, and thus, a description thereof is omitted.

In step S1405, the host PC 50 switches processing depending on whether a printing method is the electrophotographic method or the inkjet method. In the case of the inkjet method (“INKJET” in step S1405), the processing proceeds to step S1406. In the case of the electrophotographic method (“ELECTROPHOTOGRAPHIC” in step S1405), the processing proceeds to step S1411.

In the operations in step S1406 and the subsequent steps, processing of printing a multiplexed image with the inkjet method will be described. In step S1406, the host PC 50 determines whether an image region on which information is to be multiplexed is a dark portion. As a method of determining whether the image region is a dark portion is performed by calculating an average brightness from RGB values of M×N pixels, and in a case where the average brightness is smaller than a threshold value, it is determined that the region of M×N pixels is a dark portion. For the sake of explanatory convenience, the same values as horizontal and vertical sizes of the image are set as M and N. The threshold value is set to 64/255 equivalent to ¼ of a brightness range, for example. In a case where it is determined that a dark portion is included (YES in step S1406), the processing proceeds to step S1407. In a case where it is determined that a dark portion is not included (NO in step S1406), the processing proceeds to step S1408.

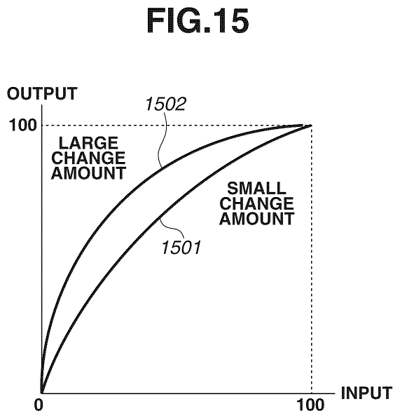

In step S1407, the host PC 50 changes the change of the density of an image region to be subjected to multiplexing. The host PC 50 acquires a bitmap image in an RGB space that has been acquired in step S1403, and changes a color space from the RGB space to a Lab space. The host PC 50 changes pixel values in changed Lab space resulting from the change, using a change table. FIG. 15 is a diagram illustrating a table to be referred to at the time of image density change, for each strength. The horizontal axis indicates an L value of input and the vertical axis indicates an L value of output. A change amount of a dark portion is small in a change table 1501, and a change amount of a dark portion is large in a change table 1502. A dark portion obtained after the conversion in the change table 1502 becomes brighter than that in the change table 1501. An L value is changed in accordance with the tables based on an input L value, thus adjusting the density of the dark portion. In the present exemplary embodiment, the change table 1501 with a small change amount is used in the inkjet method, and the change table 1502 with a large change amount is used in the electrophotographic method. A table is preset based on a measurement value in such a manner that a density value of a dark portion in each of the inkjet method and the electrophotographic method becomes a predetermined value.

In step S1407, the host PC 50 can execute multiplexing processing in the RGB space by performing density conversion of the dark portion in the Lab space using the change table 1501, and returning the converted Lap space to the RGB space.

In step S1408, the host PC 50 embeds the acquired document ID information into the bitmap image generated in step S1403 or the density-adjusted image generated in step S1407, thus generating a multiplexed image. The multiplexing processing is performed on the B plane of the image. The detailed embedding processing is similar to that described in conjunction with step S204 of FIG. 2A.

In step S1409, the host PC 50 generates a print image for the inkjet method from the multiplexed image generated in step S1408. A detailed generation method is similar to that described in conjunction with step S205 of FIG. 2A. The host PC 50 transmits the generated print image to the MFP main body 40.

In step S1410, the host PC 50 transmits the print image for the inkjet method that has been generated in step S1409, to the MFP main body 40 of the inkjet method via the data transfer I/F 504 in the host PC 50, and the MFP main body 40 performs print processing. At this time, the data transfer I/F 504 switches a print image transmission destination based on the printer model type set in step S1404.

In operations in step S1411 and the subsequent steps, processing of printing a multiplexed image with the electrophotographic method will be described.

In step S1411, as in step S1406, the host PC 50 determines whether an image region to be subjected to multiplexing is a dark portion. For the sake of explanatory convenience, the method of determining the dark portion is a method similar to that used in step S1406. A dark portion determination threshold value in the electrophotographic method may be set to a value stricter than that in the inkjet method. In a case where it is determined that a dark portion is included (YES in step S1411), the processing proceeds to step S1412. In a case where it is determined that a dark portion is not included (NO in step S1411), the processing proceeds to step S1413.

In step S1412, the host PC 50 changes the density of an image region to be subjected to the multiplexing. The host PC 50 acquires a bitmap image in an RGB space that has been acquired in step S1403, and changes a color space from the RGB space into a Lab space.

The host PC 50 changes pixel values in the Lab space resulting from the change, using the change table 1502 with a large change amount. The host PC 50 returns the converted Lab space to the RGB space.

In step S1413, the host PC 50 executes color conversion on the bitmap image generated in step S1403 or the density-converted image generated in step S1412. The detailed color conversion method is that similar to the color conversion described in conjunction with step S1209 of FIG. 12.

In step S1414, the host PC 50 performs ink color separation on the color-converted image generated in step S1413, corresponding to the number of ink colors used in the MFP main body 60. In this example, the host PC 50 separates ink color into four colors corresponding to cyan, magenta, yellow, and black. The detailed processing of the ink color separation is that similar to the ink color separation described in conjunction with step S1210 of FIG. 12.

In step S1415, the host PC 50 embeds the acquired document ID information into the ink-color-separated image generated in step S1414, thus generating a multiplexed image. The host PC 50 perform embedding processing on the Y plane of the ink-color-separated image.

In step S1416, the host PC 50 generates a print image for the electrophotographic method from the multiplexed image generated in step S1415. The host PC 50 transmits the generated print image to the MFP main body 60.

In step S1417, the host PC 50 transmits the print image for the electrophotographic method that has been generated in step S1416, to the MFP main body 60 of the electrophotographic method via the data transfer I/F 504 in the host PC 50, and the MFP main body 60 performs print processing. At this time, the data transfer I/F 504 switches a print image transmission set based on the printer model type designated in step S1404.

Heretofore, the processing of changing the density of the image for embedment, depending on the printer model type has been described.

Beneficial effects produced by the present exemplary embodiment will be described. When a document printed using the electrophotographic method is read by a scanner or a camera, light from a light source is strongly reflected in a dark portion, and the image quality of a read image sometimes degrades. Consequently, the accuracy in extracting authentic document information from the read image degrades. For this reason, a dark region density in embedding is adjusted to a lower density, and thus, it is possible to control light source reflection in reading, and reduce image degradation. This improves the accuracy in extracting authentic document information. If a multiplexed document is printed using the inkjet method, a multiplexed pattern in a dark portion is distorted due to ink bleeding, and reading accuracy sometimes decreases. To address this, a dark region density is adjusted to a lower density as in the above case, so that bleeding is reduced, the pattern is maintained, and that extraction accuracy is maintained. The density becomes lower in the inkjet method if the same density adjustment as the electrophotographic method is performed. Thus, the density adjustment on the dark portion is adjusted depending on the printing method, and thus, it is possible to keep balance between robustness and image quality in reading performance with each printing method.

The present exemplary embodiment can also be implemented by processing of supplying a program for implementing one or more functions of the above-described exemplary embodiment, to a system or an apparatus via a network or a storage medium, and one or more processors in a computer of the system or the apparatus reading out and executing the program. The present exemplary embodiment can also be implemented by a circuit (for example, application specific integrated circuit (ASIC)) for implementing the one or more functions.

According to embodiments of the present disclosure, in a system that can use a printing method other than the inkjet method or the inkjet method for recording, also in the case of embedding information using a printing process other than the inkjet method, it is possible to improve balance between information extraction accuracy from a sheet surface and image quality.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-019859, filed Feb. 13, 2024, which is hereby incorporated by reference herein in its entirety.

What is claimed is:

1. An image processing apparatus that generates a multiplexed image for executing printing in a printing machine that includes either a first apparatus using an electrophotographic method or a second apparatus using an inkjet method, the image processing apparatus comprising:
a print data acquisition unit configured to acquire print data to be printed onto a print medium;
an information acquisition unit configured to acquire embedment information; and
an image generation unit configured to embed the embedment information into the print data in such a manner that an embedment strength at which the embedment information is embedded into the same print data becomes stronger in a case where the printing machine uses the electrophotographic method than that in a case where the printing machine uses the inkjet method.

2. The image processing apparatus according to claim 1, wherein the image generation unit embeds the embedment information by changing at least one of a pattern amplitude, a pattern cycle, and an embedding targe plane of the print data corresponding to a region into which the embedment information is to be embedded.

3. The image processing apparatus according to claim 1, wherein, when the image generation unit embeds the embedment information into a spot color of the print data, the spot color is an achromatic color.

4. The image processing apparatus according to claim 1, wherein, in a case where a printing method is the inkjet method, the image generation unit performs embedding processing of embedding the embedment information into all planes of a rendering result of the print data, and in a case where the printing method is the electrophotographic method, the image generation unit executes the embedding processing on a black plane on which the print data is ink-color-separated.

5. The image processing apparatus according to claim 1, wherein the embedment information is authenticity information indicating authenticity of a document indicated by the print data.

6. An image processing method for generating a multiplexed image for executing printing in a printing machine that includes either a first apparatus using an electrophotographic method or a second apparatus using an inkjet method, the image processing method comprising:
acquiring print data to be printed onto a print medium;
acquiring embedment information; and
embedding the embedment information into the print data in such a manner that an embedment strength at which the embedment information is embedded into the same print data becomes stronger in a case where the printing machine uses the electrophotographic method than that in a case where the printing machine uses the inkjet method.

7. A non-transitory computer-readable storage medium storing instructions that, when executed by a computer, cause the computer to perform an image processing method for generating a multiplexed image for executing printing in a printing machine that includes either a first apparatus using an electrophotographic method or a second apparatus using an inkjet method, the image processing method:
acquiring print data to be printed onto a print medium;
acquiring embedment information; and
embedding the embedment information into the print data in such a manner that an embedment strength at which the embedment information is embedded into the same print data becomes stronger in a case where the printing machine uses the electrophotographic method than that in a case where the printing machine uses the inkjet method.
